(19) United States
(12) Patent Application Publication
(10) Pub. No.: US 2023/0191501 A1
(43) Pub. Date: Jun. 22, 2023

(54) CUTTING INSERT, USE THEREOF AND MACHINING METHOD

(71) Applicant: CERATIZIT AUSTRIA GESELLSCHAFT M.B.H., Reutte (AT)

(72) Inventor: Christian Goeberl, Reutte (AT)

(21) Appl. No.: 17/924,764

(22) PCT Filed: Mar. 3, 2021
(86) PCT No.: PCT/EP2021/058422

§ 371 Date: Nov. 11, 2022

(30) Foreign Application Priority Data
May 13, 2020 (EP) 20174465.3

(51) Int. Cl. B23B 27/22; B23B 27/16

(52) U.S. Cl. CPC B23B 27/22; B23B 27/16; B23B 2200/049; B23B 2200/085; B23B 2200/323

(57) ABSTRACT

A cutting insert, for producing a V-shaped profile in a workpiece by radial piercing relative to an axis of rotation of the workpiece, includes a reference plane and a V-shaped insertion region. The V-shaped insertion region includes, inter alia, two cutting edges in the reference plane, a rake face and a plurality of elongated chip-guiding depressions in the rake face, each extending in parallel with a depression axis of extent or extension axis in the reference plane, providing improved chip formation compared to the prior art. The depression axes of extent or extension axes each extend at a recess chip-guiding angle in a region of 0° to 45°. A method of using the cutting insert and the workpiece at a standstill and a machining method are also provided.

The present invention relates to a cutting insert which is designed for producing a V-shaped profile in a workpiece by radial piercing with respect to an axis of rotation of the workpiece, having a reference plane and a V-shaped piercing region, the V-shaped piercing region having two cutting edges which are contained in the reference plane and converge in a V-shaped manner towards each other in a viewing direction perpendicular to the reference plane, a cutting edge angle which can be measured between the cutting edges in a viewing direction perpendicular to the reference plane and lies in the range of 20° to 60°, an axis of symmetry contained in the reference plane and with respect to which the cutting edges are formed mirror-symmetrically to each other, a rake face, a plurality of elongate chip-guiding depressions in the rake face, said chip-guiding depressions each having a low point lying below the reference plane and each extending to a depression axis of extent contained in the reference plane, in a viewing direction perpendicular to the reference plane, and a cutting corner via which the two cutting edges are connected to each other.

The present invention furthermore relates to use of such a cutting insert.

Finally, the present invention relates to a machining method in which such a cutting insert is provided.

A cutting insert of the type mentioned at the beginning is used in particular in the production of V-belt pulleys from the workpiece by the cutting insert being pierced radially into the workpiece with respect to the workpiece axis of rotation. By means of this piercing, when the cutting insert or the workpiece is rotated about the workpiece axis of rotation, a V-shaped peripheral groove is produced in the workpiece, in which groove a V belt for driving a V-belt pulley produced in such a way can engage.

However, the piercing customarily produces long chips, for example long tangled chips. This is problematic because long chips frequently wind around the workpiece or the cutting insert. Process malfunctions during the piercing and damage to the cutting insert occur as a result. In addition, long chips frequently have to be removed manually. This conventionally leads to machine downtimes, which reduces the productivity. The formation of long chips should consequently be avoided.

The cutting insert according to EP 1 454 690 A1 therefore has a rake surface with a depression which extends along the cutting edge in order to promote chip breaking.

However, it has been shown that such a formed rake surface does not provide sufficient chip breaking when piercing ductile material.

It is therefore the object of the present invention to specify in each case a cutting insert, use of the cutting insert and a machining method with in each case a chip formation that is improved in comparison to the prior art.

The object is achieved by the cutting insert according to claim 1. Advantageous developments of the cutting insert according to claim 1 can be gathered from the claims which are dependent on claim 1.

The cutting insert which is designed for producing a V-shaped profile in a workpiece by radial piercing with respect to an axis of rotation of the workpiece has a reference plane and a V-shaped piercing region, the V-shaped piercing region having two cutting edges which are contained in the reference plane and converge in a V-shaped manner towards each other in a viewing direction perpendicular to the reference plane, a cutting edge angle which can be measured between the cutting edges in a viewing direction perpendicular to the reference plane and lies in the range of 20° to 60°, an axis of symmetry contained in the reference plane and with respect to which the cutting edges are formed mirror-symmetrically to each other, a rake face, a plurality of elongate chip-guiding depressions in the rake face, said chip-guiding depressions each having a low point lying below the reference plane and each extending parallel to a depression axis of extent contained in the reference plane, in a viewing direction perpendicular to the reference plane, and a cutting corner via which the two cutting edges are connected to each other, wherein the depression axes of extent each extend at a depression chip-guiding angle in the range from 0° to 45°, wherein the depression chip-guiding angle can in each case be measured on the side of the cutting corner between the axis of symmetry and the depression axis of extent in a viewing direction perpendicular to the reference plane. The advantage of this cutting insert consists in that the chip-guiding depressions are used for the chip formation which is undertaken plastically in such a manner that sliding of the chip into the respective chip-guiding depression causes beads to be produced in the chip along the longitudinal axis of the chip, the beads leading to stiffening of the chip, and therefore the chip can break more easily in comparison to the prior art. It has been shown that this positive effect no longer occurs if the depression chip-guiding angle lies outside the range from 0° to 45°.

If the depression chip-guiding angle is 0°, the chip-guiding depressions each extend parallel to the axis of symmetry in a viewing direction perpendicular to the reference plane. If the depression chip-guiding angle lies in the range greater than 0° to 45°, the chip-guiding depressions extend obliquely with respect to the axis of symmetry in a viewing direction perpendicular to the reference plane.

The fact that the depression chip-guiding angle can in each case be measured on the side of the cutting corner between the axis of symmetry and the depression axis of extent in a viewing direction perpendicular to the reference plane means that the one limb of the depression chip-guiding angle is a portion of the depression axis of extent in the region of the chip-guiding depression and the other limb of the depression chip-guiding angle is in each case a portion of the axis of symmetry on the side of the cutting corner.

Within the meaning of the present disclosure, the two cutting edges can each be rectilinear, convex or concave, wherein they are in each case formed mirror-symmetrically to each other with respect to the axis of symmetry.

The cutting corner can be punctiform or linear in a viewing direction perpendicular to the reference plane. If it is linear, it may be, for example, circular, oval or polygonal.

Within the meaning of the present disclosure, the reference plane is an imaginary plane in which the cutting edges are contained.

The term V-shaped means the shape of the letter V, wherein the sides of the V may be rectilinear, convex or concave and the tip of the V may be punctiform or linear. If it is linear, it may be, for example, circular, oval or polygonal.

According to a development of the cutting insert, the depression chip-guiding angle lies in the range from 10° to 40°. It has been shown that this narrower range leads to an even shorter chip breaking. A further improvement in this respect occurs in the range from 10° to 20°. The range from 12° to 18° is most preferred.

According to a development of the cutting insert, at least two of the depression axes of extent are arranged mirror-symmetrically to the axis of symmetry in a viewing direction perpendicular to the reference plane. As a result, in each case at least one chip-guiding depression is provided for each of the two cutting corners, and therefore a conventionally symmetrical cutting condition is taken into account in the piercing.

According to a development of the cutting insert, the chip-guiding depressions in a viewing direction perpendicular to the reference plane each have a maximum length, measured parallel to the depression axis of extent, and each have a maximum width, measured perpendicularly to the depression axis of extent, wherein the ratio between the length and width is in each case in the range from 1.1 to 20. This is advantageous because the chip-guiding depressions are therefore designed as elongate flutes which can accordingly guide the chips laterally and in the chip discharge direction. It has been shown that the range from 1.1 to 10 is particularly readily suitable for this effect. The range from 3 to 8 is most preferred.

According to a development of the cutting insert, the cutting corner is linear in a viewing direction perpendicular to the reference plane and has a maximum cutting corner width, measured in the reference plane perpendicular to the axis of symmetry, wherein, in a viewing direction perpendicular to the reference plane, the chip-guiding depressions keep to a minimum distance, measured parallel to the axis of symmetry, from a point of intersection of the cutting corner with the axis of symmetry, said minimum distance being greater by a factor of 1 to 3 than the cutting corner width. By the chip-guiding depressions keeping to said minimum distance, differently shaped chip-guiding depressions can be provided between the chip-guiding depressions and the cutting corner in a viewing direction perpendicular to the reference plane. This is expedient because, in such a cutting corner region, which is defined in a viewing direction perpendicular to the reference plane, different cutting conditions prevail during the piercing in comparison to the remaining region of the V-shaped piercing region, and therefore a chip formation which is adapted thereto can be realized.

According to a development of the cutting insert, the rake face has a plurality of chip-guiding elevations which each extend to above the reference plane and are arranged alternately alternating with the chip-guiding depressions in a viewing direction perpendicular to the reference plane. Owing to such an arrangement, the chip-guiding elevations provide improved chip guidance which acts counter to the chips deviating laterally as they emerge from the respective chip-guiding depression. By this means, the chip can be bent upward over greater radii until it breaks.

According to a development of the cutting insert, the chip-guiding elevations are elongate and each extend parallel to an elevation axis of extent contained in the reference plane in a viewing direction perpendicular to the reference plane, wherein the elevation axes of extent each extend at an elevation chip-guiding angle in the range from 0° to 45°, wherein the elevation chip-guiding angle can in each case be measured on the side of the cutting corner between the elevation axis of extent and the axis of symmetry in a viewing direction perpendicular to the reference plane. It has been shown that the chip guidance is thereby improved even further because, owing to the elevation chip-guiding angle in the range from 0° to 45°, the chips are guided away even further from the cutting edge and the workpiece. The elevation chip-guiding angle is measured analogously to the depression chip-guiding angle. The elevation chip-guiding angle preferably lies in a narrower range of in the range from 0° to 45°, even more preferably in the range from 10° to 20°, and, most preferably, the range extends from 12° to 18°.

According to a development of the cutting insert, the chip-guiding elevations and the chip-guiding depressions are arranged alternately alternating in a viewing direction perpendicular to the reference plane, wherein the depression chip-guiding angle of one of the chip-guiding depressions has a difference from one of the elevation chip-guiding angles, said elevation chip-guiding angle belongs to a chip-guiding elevation which directly follows the chip-guiding depression in a viewing direction perpendicular to the reference plane, and the difference lies in the range from 0° to 15°. It has been shown that, according to this development, the chip breaking is promoted even more and the discharging chip as it emerges from the chip-guiding depression is guided away from the cutting corner in the direction of the axis of symmetry. This effect is reinforced in the narrower range from greater than 0° to 15°.

According to a development of the cutting insert, the cutting edge angle lies in the range from 35° to 45°. This is particularly expedient for the production of the V-shaped profile because the V-shaped profile then has an opening angle between the sides of the V that is equal to the cutting edge angle from this range, wherein, as a result, the opening angle is firstly of a sufficiently small size, which is advantageous for the lateral guidance of a V belt, and, secondly, leads to a sufficiently large contact surface for the V belt within the V-shaped profile, which is advantageous for frictionally transmitting force from the V belt to the workpiece. This effect is reinforced in the narrower range from 38° to 42°.

According to a development of the cutting insert, at least one of the chip-guiding depressions has an unground, sintered surface. In comparison to a ground surface, such a surface has improved quality and/or a smaller dimensional tolerance, and therefore an even more precise chip formation is possible. The unground, sintered surface is obtainable, for example, by compressing a pulverulent starting material which is subsequently sintered. The unground, sintered surface can also be coated with a hard material layer, which reduces the wear of the cutting insert.

The surface of the rake face can also be unground and sintered outside the at least one chip-guiding depression, which has an unground, sintered surface. This improves the quality and/or reduces the dimensional tolerance of the rake face.

Each of the cutting edges connects the rake face to a respective flank. At least one of the flanks, preferably both flanks, has an unground, sintered surface. This improves the quality and/or reduces the dimensional tolerance of the flank.

It is expressly stated at this juncture that it is particularly advantageous if at least one of the cutting edges, preferably both cutting edges, has/have an uninterrupted profile by the chip-guiding depressions each being spaced apart from the cutting edge or the two cutting edges in a viewing direction perpendicular to the reference plane. This measure improves the stability of the cutting edges. The distance, in each case measured perpendicularly to the cutting edge in a viewing direction perpendicular to the reference plane, between the respective chip-guiding depression and the cutting edge can be, for example, in the range from 0.01 mm to 0.1 mm, preferably 0.01 mm to 0.08 mm.

According to a development of the cutting insert, the cutting insert has at least one second V-shaped piercing region, the second V-shaped piercing region having two cutting edges which are contained in the reference plane and converge in a V-shaped manner towards each other in a viewing direction perpendicular to the reference plane, wherein the two cutting edges of the second V-shaped piercing region are arranged directly following the two cutting edges of the first V-shaped piercing region perpendicular to the axis of symmetry. This cutting insert is advantageous because the at least two V-shaped profiles required for a V-ribbed belt are produced in the workpiece by a radial piercing movement with said cutting insert. The second piercing region conventionally has a cutting corner which is designed analogously to the cutting corner of the first V-shaped piercing region. The second piercing region is preferably designed analogously to the first piercing region, and therefore the advantageous chip formation of the first piercing region is also provided in and/or on the rake face of the second piercing region.

It is conceivable and also possible for three, four, five, six, seven, eight, nine, ten or even more V-shaped piercing regions to be provided, wherein said piercing regions are each designed like the first or second V-shaped piercing region and are arranged directly following the respective previous piercing region perpendicular to the axis of symmetry. This is advantageous because the V-shaped pulley is intended to be produced with more than two grooves.

The object is also achieved by the use according to claim 12 or according to one of the claims dependent on claim 12 by the cutting insert according to claim 1 or according to one of the claims dependent on claim 1 being used for radially piercing a workpiece with respect to an axis of rotation of the workpiece, wherein the cutting insert or the workpiece is rotated about the workpiece axis of rotation. An advantage of this use is that the cutting insert owing to its chip-guiding depressions which interact with the optional chip-guiding elevations counteracts the formation of long chips, in particular tangled chips.

According to a development of the use of the cutting insert, the cutting insert and the workpiece are at a standstill with respect to each other in the axial direction with respect to the workpiece axis of rotation during the radial piercing. Accordingly, during the radial piercing, no relative movement takes place between the cutting insert and the workpiece in the axial direction with respect to the workpiece axis of rotation. Owing to their arrangement and dimensions, the chip-guiding depressions and the optional chip-guiding elevations are particularly readily suitable for forming beads and guiding chips away from the cutting edges and the workpiece during such radial piercing.

The object is also achieved by a machining method according to claim 14 or according to one of the claims which are dependent on claim 14.

In the machining method for producing a V-shaped profile in a workpiece, the following steps are carried out: a) providing a workpiece with a workpiece axis of rotation, b) providing the cutting insert according to claim 1 or according to one of the claims which are dependent on claim 1, c) rotating the workpiece or the cutting insert about the workpiece axis of rotation, d) radially moving the workpiece and the cutting insert towards each other with respect to the workpiece axis of rotation such that the cutting corner of the cutting insert first of all pierces the workpiece, e) continuing the moving towards each other from step d) such that the two cutting edges penetrate the workpiece at least in sections. An advantage of this method is that the cutting insert, owing to its chip-guiding depressions which interact with the optional chip-guiding elevations, counteracts the formation of long chips, in particular tangled chips.

According to a development of the method, in step e), the cutting insert and the workpiece are at a standstill with respect to each other in the axial direction with respect to the workpiece axis of rotation. Accordingly, during the radial piercing, there is no relative movement between the cutting insert and the workpiece in the axial direction with respect to the workpiece axis of rotation. It has been shown that, owing to their arrangement and dimensions, the chip-guiding depressions and the optionally provided chip-guiding elevations are particularly readily suitable for forming beads and guiding chips away from the cutting edges of the workpiece during such radial piercing.

Further advantages and expediencies of the invention emerge on the basis of the description below of exemplary embodiments with reference to the attached figures.

In the figures:

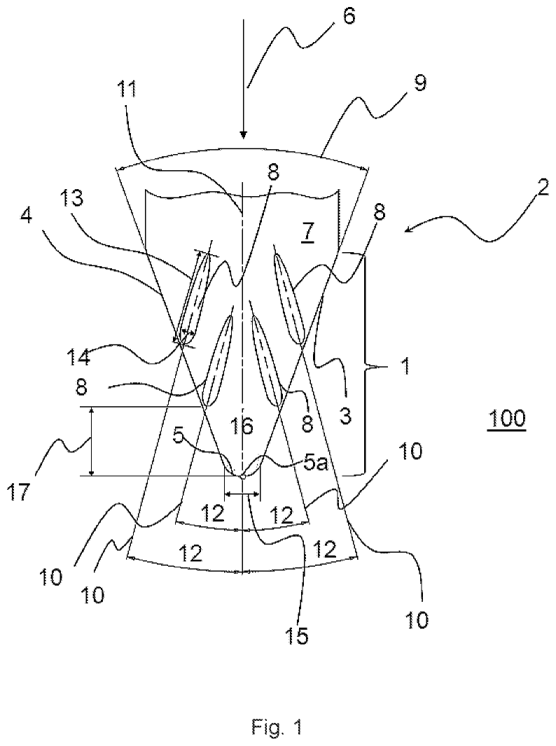

FIG. 1: shows a schematic illustration of a front portion of a cutting insert according to a first embodiment in the region of a V-shaped piercing region in a viewing direction perpendicular to a reference plane;

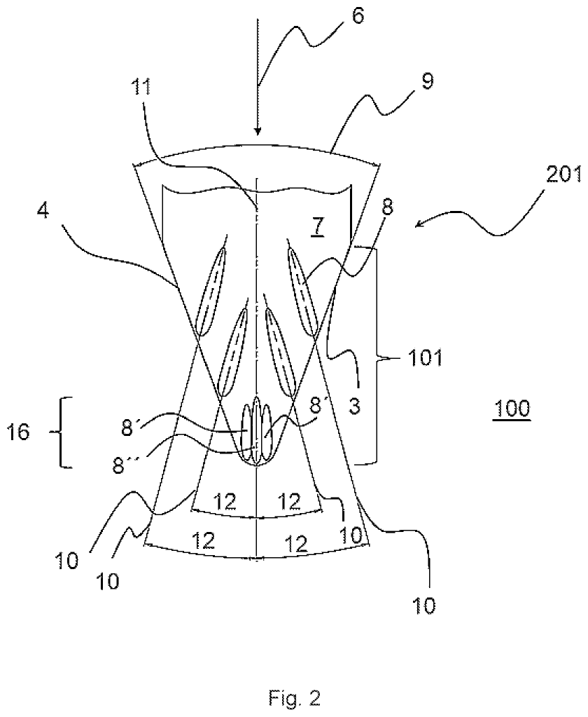

FIG. 2: shows a schematic illustration of a front portion of a cutting insert according to a second embodiment in the region of a V-shaped piercing region in a viewing direction perpendicular to a reference plane;

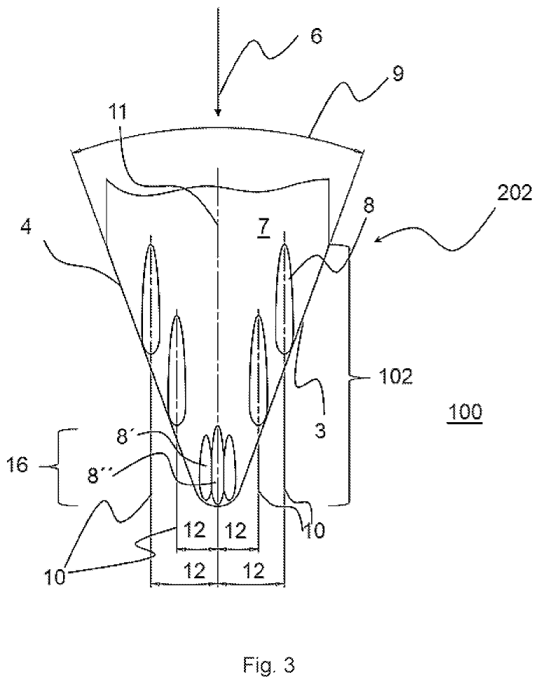

FIG. 3: shows a schematic illustration of a front portion of a cutting insert according to a third embodiment in the region of a V-shaped piercing region in a viewing direction perpendicular to a reference plane;

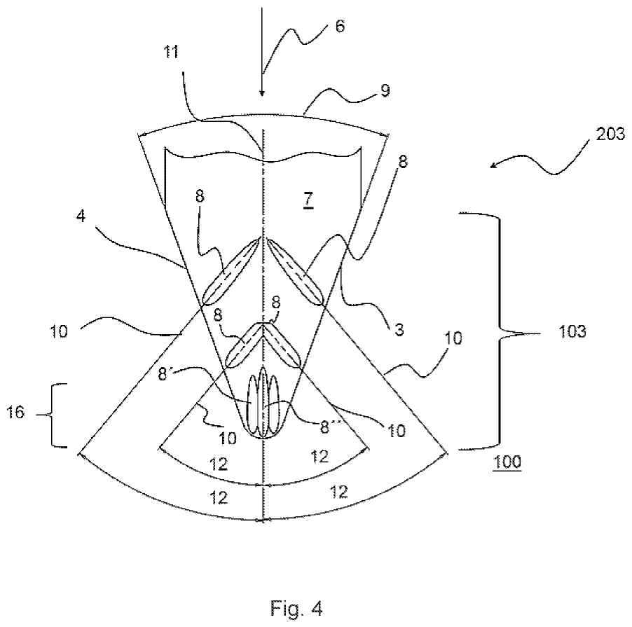

FIG. 4: shows a schematic illustration of a front portion of a cutting insert according to a fourth embodiment in the region of a V-shaped piercing region in a viewing direction perpendicular to a reference plane;

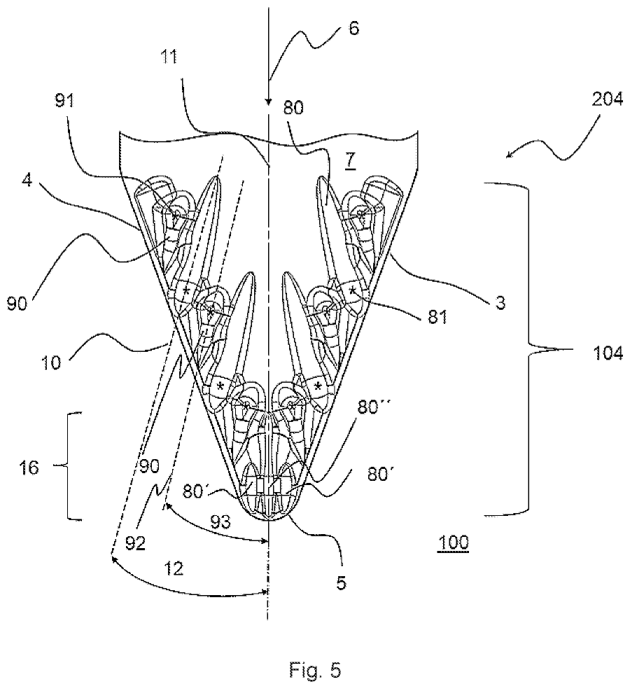

FIG. 5: shows a schematic illustration of a front portion of a cutting insert according to a fifth embodiment in the region of a V-shaped piercing region in a viewing direction perpendicular to a reference plane;

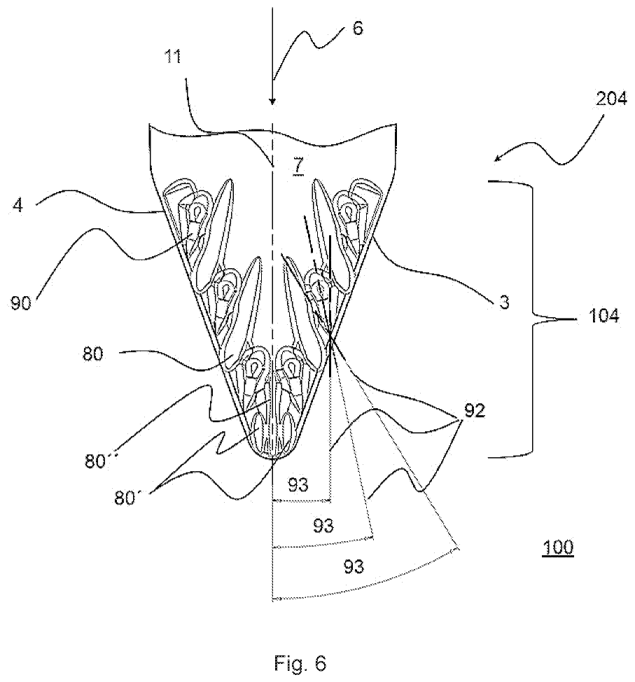

FIG. 6: shows the illustration from FIG. 4 with end positions, shown by way of example, of an elevation axis of extent;

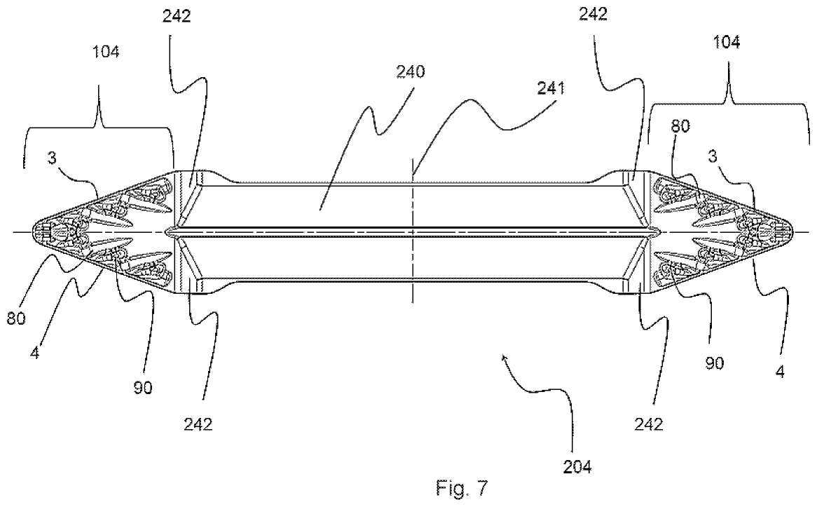

FIG. 7: shows a schematic illustration of the complete cutting insert according to the fifth embodiment with two mutually diametric V-shaped piercing regions in a top view of a shaft connecting the piercing regions;

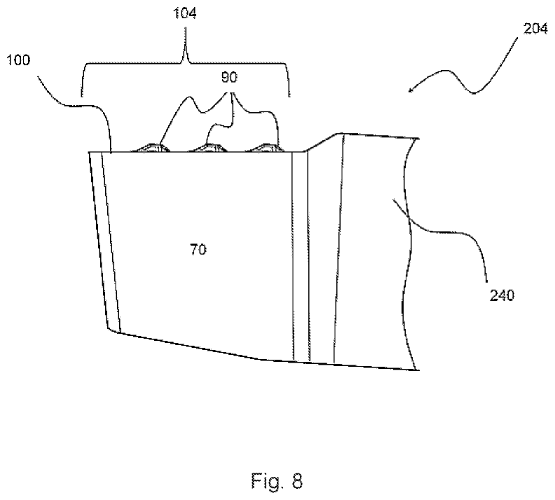

FIG. 8: shows a schematic illustration of the front portion of the cutting insert according to the fifth embodiment in the region of one of its two V-shaped piercing regions in a viewing direction to the side of a flank;

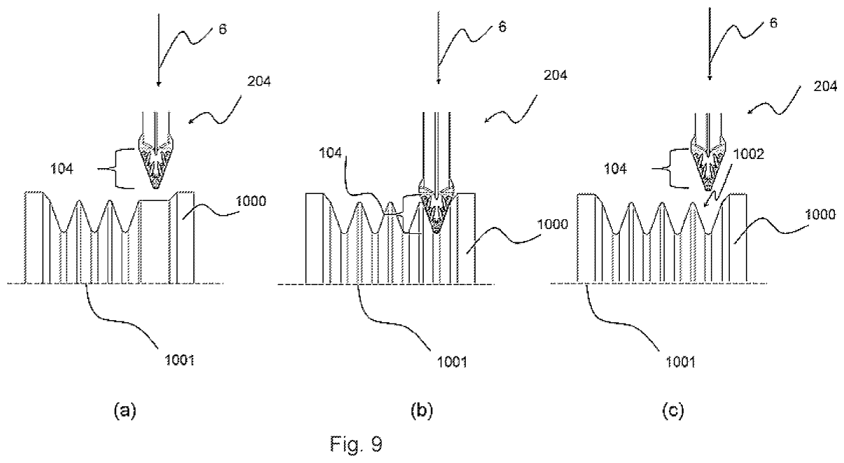

FIG. 9: shows a schematic illustration of a piercing method carried out with the cutting insert according to the fifth embodiment;

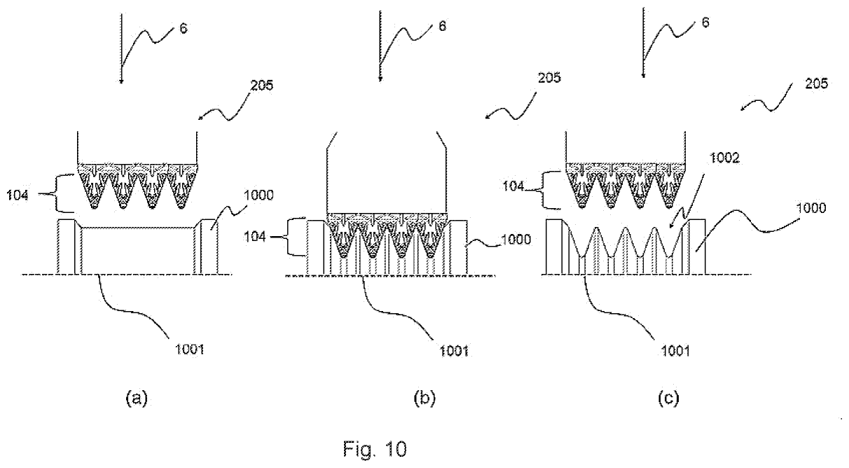

FIG. 10: shows a schematic illustration of a piercing method carried out with a cutting insert according to a sixth embodiment;

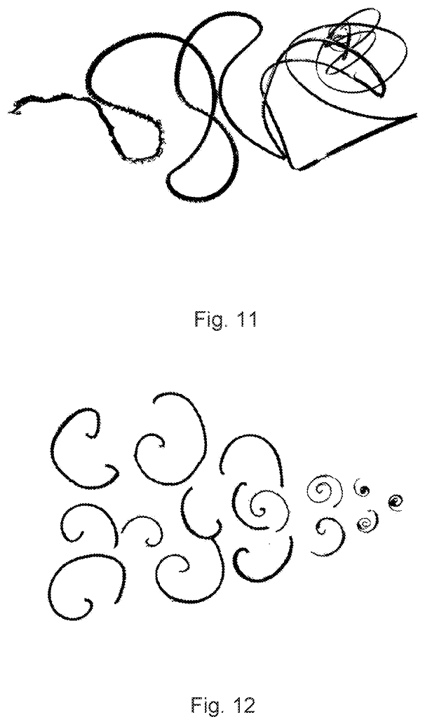

FIG. 11: shows a chip which has been produced with a cutting insert without chip-guiding depressions according to the present disclosure;

FIG. 12: shows chips which have been produced with the cutting insert according to the fifth embodiment.

The V-shaped piercing region 1 shown in FIG. 1 of a sectionally illustrated cutting insert 2 according to a first embodiment has a reference plane 100 which coincides with the plane of the drawing of FIG. 1. The viewing direction selected in FIG. 1 is perpendicular to the reference plane 100. Two rectilinear cutting edges 3 and 4 of the piercing region 1 are contained in the reference plane 100. The cutting edges 3 and 4 converge in a V-shaped manner towards each other, are formed mirror-symmetrically to each other with respect to an axis of symmetry 11 contained in the reference plane 100 and enclose a cutting edge angle 9 in the reference plane 100. The cutting edge angle 9 is 40°, by way of example.

The cutting edges 3 and 4 are connected to each other via a rounded cutting corner 5 contained in the reference plane 100. A feeding direction 6 is conventionally oriented radially with respect to an axis of rotation of a metallic workpiece. If the cutting insert 2 with the cutting corner 5 is first of all pierced radially into the workpiece, which rotates about the axis of rotation, parallel to the feeding direction 6 into the workpiece and the cutting edges 3 and 4 penetrate the workpiece in the process, a profile which is designed following the V-shaped profile of the piercing region 1, i.e. is V-shaped with an opening angle of 40°, is consequently produced in the workpiece.

Chips are produced during such radial piercing. The chips are discharged along a rake face 7 of the piercing region 1. The rake face 7 is delimited in the reference plane 100 by the cutting edges 3 and 4 and by the cutting corner 5. The rake face 7 has drop-shaped chip-guiding depressions 8 which each have a low point in the vicinity of the cutting edge (cf. in this respect FIG. 5 where the low points are shown). The low points lie below the reference plane 100 with respect to the viewing direction, which is selected in FIG. 1, perpendicular to the reference plane 100. The chips each run into the chip-guiding depressions 8. The chips are compressed at the respective low point, and therefore the chips roll upwards out of the reference plane 100. As they roll, the chips break.

The shape and orientation of the chip-guiding depressions 8 act advantageously to the effect that beads are impressed in the discharging chips. The beads act as folding points and predetermined breaking points, which facilitates the rolling and breaking of the chips.

The chip-guiding depressions 8 each extend parallel to a depression axis of extent 10 contained in the reference plane 100. The depression axes of extent 10 each enclose a depression chip-guiding angle 12 with the axis of symmetry 11, which depression chip-guiding angle can be measured on the side of the cutting corner 5 and is contained in the reference plane 100. The depression chip-guiding angles 12 are in each case 15°, by way of example.

The chip-guiding depressions 8 each have a maximum length 13, measured parallel to their depression axis of extent 10, and a maximum width 14, measured perpendicularly to their depression axis of extent 10. The ratio between the maximum length 13 and the maximum width is in each case 5.4.

It has been shown that such a selected elongate shape of the chip-guiding depressions 8 is advantageous for chip guidance away from the cutting edges 3 and 4 and the cutting corner 5 to a stop surface, which will be discussed in more detail with reference to FIG. 7.

The cutting corner 5 has a maximum width 15, measured in the reference plane 100 perpendicularly to the axis of symmetry 11, at the transition to the cutting edges 3 and 4. From an intersecting point 5a, contained in the reference plane 100, of the cutting corner 5 with the axis of symmetry 11, a front region 16 of the rake face 7 extends to the front two chip-guiding depressions 8 in the selected viewing direction from FIG. 1 perpendicular to the reference plane 100. The region 16 has a maximum length 17, measured in the reference plane 100 parallel to the axis of symmetry 11. The ratio between the maximum length 17 and the maximum width 15 is 2.3, by way of example.

It has been shown that such a shaped region 16 is advantageous for the design of the cutting insert 2 to the effect that further chip-guiding depressions 8 can be provided in the region 16, said chip-guiding depressions being able to have different depression chip-guiding angles and/or shapes in comparison to the chip-guiding depressions 8 illustrated in FIG. 1. This is because the chip-forming conditions are different in the region 16 from the chip-forming conditions outside same.

In the viewing direction, selected from FIG. 1, perpendicular to the reference plane 100, the chip-guiding depressions 8 are formed in pairs mirror-symmetrically to one another with respect to the axis of symmetry 11 because the chip-forming conditions at the cutting edges 3 and 4 are conventionally symmetrical to one another with respect to the axis of symmetry 11. The depression axes of extent 10 are accordingly likewise symmetrical with respect to the axis of symmetry 11 in a viewing direction perpendicular to the reference plane 100.

The V-shaped piercing region 101, shown in FIG. 2, of a sectionally illustrated cutting insert 201 according to a second embodiment is designed analogously to the piercing region 1, with the difference that, in the front region 16 of the rake face 7, there are three additional chip-guiding depressions 8′ and 8″ which act analogously to the other chip-guiding depressions 8, but, in a viewing direction perpendicular to the reference plane 100, each extend from depression axes of extent—not illustrated for clarity reasons—which are each contained in the reference plane 100 parallel to the axis of symmetry 11, i.e. each have a depression chip-guiding angle of 0°. It has been shown that a depression chip-guiding angle of 0° is optimum in the region 16 for forming beads when discharging chips over the rake face 7. The front chip-guiding depression 8′ which is arranged on the side of the cutting edge 3 in a viewing direction perpendicular to the reference plane 100 is arranged and formed mirror-symmetrically with respect to the axis of symmetry 11 to the front chip-guiding depression 8′ arranged on the side of the cutting edge 4. The middle of the front chip-guiding depressions 8″ is mirror-symmetrical with respect to the axis of symmetry 11 and is longer, parallel to said direction, than each of the chip-guiding depressions 8′.

With respect to the front chip-guiding depressions 8′ and 8″, the maximum length, measured analogously to the other chip-guiding depressions 8, is in each case smaller than the maximum length 13 and their maximum width 14, measured analogously to the other chip-guiding depressions 8, is in each case smaller. The middle of the three front chip-guiding depressions 8″ in a viewing direction perpendicular to the reference plane 100 thus has a ratio of 7.5 with respect to its maximum length to its maximum width. The two other front chip-guiding depressions 8′ arranged on the side of the cutting edge 3 and on the side of the cutting edge 4, in each case in a viewing direction perpendicular to the reference plane 100, have an analogously dimensioned ratio of in each case 5.8. The chip-guiding depressions 8′ and 8″ formed in such a way have a favourable effect on the chip guidance away from the cutting edge 5 parallel to the axis of symmetry 11, and therefore this takes place parallel to the axis of symmetry 11.

The V-shaped piercing region 102, shown in FIG. 3, of a sectionally illustrated cutting insert 202 according to a third embodiment, is designed analogously to the piercing region 101 with the difference that the depression axes of extent 10 each have a depression chip-guiding angle 12 of 0°, i.e. the depression axes of extent 10 run parallel to the axis of symmetry 11 in the reference plane 100. It has been shown that, even at such depression chip-guiding angles 12 of 0°, beads are formed in the chips. The front region 16 may also be formed without chip-guiding depression 8′ and 8″.

The V-shaped piercing region 103, shown in FIG. 4, of a sectionally illustrated cutting insert 203 according to a fourth embodiment is designed analogously to the piercing region 101, with the difference that the depression axes of extent 10 each have a depression chip-guiding angle 12 of 40°. It has been shown that, even at such depression chip-guiding angles 12 of 40°, beads are formed in the chips. The region 16 of the piercing region may also be formed without chip-guiding depressions 8′ and 8″.

The V-shaped piercing region 104, shown in FIG. 5, of a sectionally illustrated cutting insert 204 according to a fifth embodiment is designed analogously to the piercing region 101, with there being differences with regard to the design of the rake face 7.

The rake face 7 of the piercing region 104 has chip-guiding depressions 80 which act analogously to the chip-guiding depressions 8 and the depression axes of extent 10 of which each span the depression chip-guiding angle 12 with the axis of symmetry 11 in the reference plane 100 on the side of the cutting corner 5. The depression chip-guiding angle 12 of the chip-guiding depressions 80 is in each case 15°, as in the case of the chip-guiding depressions 8 from FIG. 2. Each of the chip-guiding depressions 80 in each case has a low point 81 which lies below the reference plane 100 in a viewing direction perpendicular to the reference plane 100. In a viewing direction perpendicular to the reference plane 100, the low points 81 are each at a distance, measured parallel to the respective depression axis of extent 10, from the cutting edge 3 or 4, which distance is 25% of a maximum length of the respective chip-guiding depressions 80 measured analogously to the length 13 from FIG. 1; the low points of the chip-guiding depressions 8 according to FIGS. 1 to 4 are arranged analogously. The chip formation therefore takes place substantially in the vicinity of the cutting edges.

In contrast to the rake face 7 of the piercing region 101, the rake face 7 of the piercing region 104 additionally has rib-shaped chip-guiding elevations 90 which each extend above the reference plane 100 as far as a respective high point 91 and converge in a wedge-shaped manner at the respective cutting edge 3 or 4 in a viewing direction perpendicular to the reference plane 100. The reference plane 100 is consequently located between the high points 91 and the low points 81. The chip-guiding elevations 90 are each arranged alternating alternatively with the chip-guiding depressions 80 along the cutting edges 3 and 4, and therefore each chip-guiding depression 80 is arranged between two chip-guiding elevations 90. Chip-guiding elevations 90 arranged in such a way prevent the chips from breaking out laterally as emerge from the chip-guiding depressions 80.

The chip-guiding elevations 90 extend analogously to the chip-guiding depressions 80 in each case parallel to the one elevation axis of extent 92 which is contained in reference plane 100 and in each case encloses with the axis of symmetry 11 an elevation chip-guiding angle 93 on the side of the cutting corner 5, said elevation chip-guiding angle in each case being smaller than the depression chip-guiding angle 12 of an immediately adjacent chip-guiding depression 80. It has been shown that such a difference promotes the chip breaking into smaller chips as the chips emerge from the chip-guiding depressions 80. The elevation chip-guiding angles 93 are thus 12° in each case. The difference between the depression chip-guiding angle 12 of one of the chip-guiding depressions 80, which directly follows a chip-guiding elevation 90 in the direction along the cutting edge 3 or 4, and the elevation chip-guiding angle 93 of said chip-guiding elevation 90 is consequently in each case 3°.

Two front chip-guiding depressions 80′ are formed analogously to the chip-guiding depressions 8′. A chip-guiding depression 80″ arranged between the two chip-guiding depressions 80′ in a viewing direction perpendicular to the reference plane 100 is formed analogously to the chip-guiding depression 80, with the difference that the chip-guiding depression 80″ is narrowed inwards in a viewing direction perpendicular to the reference plane 100 into the axis of symmetry 11, which promotes the chip breaking in this region.

It can be seen with reference to the profile lines in FIG. 5 that the chip-guiding depressions 80, 80′ and 80″ and the chip-guiding elevations 90 are in each case faceted, as is obtainable by direct pressing of a pulverulent blank of the cutting insert 204 and subsequent sintering. The rake face 7 is unground here.

It can be seen in FIG. 6 that, in accordance with the illustrated end positions of the elevation axis of extent 92, the elevation chip-guiding angle 93 can be in the range from 0° (parallel to the axis of symmetry 11) to 31°; however, an alternative range of the elevation chip-guiding angle 93 from 0° to 40° is conceivable and also possible. In an analogous way, FIGS. 1 to 4 show, in an overall view, that the depression chip-guiding angle 12 can in each case be in the range from 0 to 40°, 0° to 15° and 15° to 40°. The respectively disclosed ranges of the elevation chip-guiding angle 93 (0° to 31°, 31° to 40° and 0° to 40° can each be combined with one of the disclosed ranges of the depression chip-guiding angle 12 (0 to 40°, 0 to 15° and 15° to 40° if the elevation chip-guiding angle 93 is smaller than the depression chip-guiding angle 12. As is shown, the chip breaking is promoted by such a combination.

FIG. 7 shows the complete cutting insert 204 in a top view. The cutting insert 204 has a shaft 240 via which the cutting insert 204 can be clamped in a tool holder. The cutting insert 204 has the piercing region 104 twice, specifically at opposite ends of the shaft 240 diametrically and equidistantly from each other with respect to an axis of symmetry 241 of the shaft 240. Consequently, either the one or the other piercing region 104 can be used for the piercing by the cutting insert 204 being rotated by 180° about an axis of rotation which is perpendicular to the plane of the drawing of FIG. 7.

It can also be seen in FIG. 7 that the cutting insert 204 in each case has a stop surface 242 on the side of the cutting edges 3 and 4. The chip-guiding depressions 80 and the chip-guiding elevations 90 are oriented in such a manner that the chips are guided towards the stop surfaces 242. If, owing to guidance realized in such a manner, the chips collide with the stop surfaces 242, the chip breaking is additionally promoted. The chip guidance therefore also contributes to the chip breaking.

In the side view, shown in FIG. 8, in a viewing direction parallel to the reference plane 100 of a flank 70 of the piercing region 104, it can be seen particularly readily that the chip-guiding elevations 90 extend to above the reference plane 100 and in this way prevent chips from breaking out laterally.

FIGS. 9a to 9c show the cutting insert 204 in sections in the region of the piercing region 104 during the piercing in a workpiece 1000. FIG. 9a thus shows the piercing region 104 in one position, while said piercing region is moved onto the workpiece 1000 perpendicularly (radially) in the direction 6 of an axis of rotation 1001 of the workpiece 1000. The workpiece 1000 rotates about the axis of rotation 1001 in FIGS. 9a to 9c; however, it is also conceivable and possible for the workpiece 1000 to be at a standstill and the piercing region 104 and therefore the cutting insert 204 to be rotated about the workpiece axis of rotation 1001. FIG. 9b shows the piercing region 104 while the latter pierces the workpiece 1001. FIG. 9c shows the piercing region 104 after the latter has been moved out of the workpiece 1000 in the opposite direction to the direction 6. As can be seen in FIG. 9c, the piercing in the workpiece 1001 has produced a V-shaped profile 1002; this may also be referred to as a V-shaped groove 1002 which is circumferential with respect to the axis of rotation 1001 because the workpiece 1000 has carried out a full revolution about the axis of rotation 1001 during the piercing position according to FIG. 9b. By means of the workpiece 1000, a V-belt pulley is then provided in FIG. 9c, in which a V belt following the V profile 1002 in cross section can engage.

FIGS. 10a to 10c show a cutting insert 205 according to a sixth embodiment in sections in the region of its fourfold piercing region 104 during piercing the workpiece 1000 analogously to FIGS. 9a to 9c. The individual piercing regions 104 are arranged next to one another perpendicular to the axis of symmetry 11 in the reference plane 100 with respect to FIG. 5, and therefore, by means of a piercing operation according to FIGS. 10a to 10c, four of the V-shaped profiles 1002 are produced in the workpiece 1000 by a piercing operation.

During the piercing according to FIGS. 9a to 9c and FIGS. 10a to 10c, the workpiece 1000 is conventionally at a standstill in relation to the cutting insert 204 or 205 with respect to an axial feeding direction contained perpendicular to the direction in the respective drawing plane. Alternatively, it is conceivable and also possible for a relative movement to in each case take place in such an axial direction in order to widen the V-shaped profiles in this direction.

The action of the cutting insert 204 and therefore of the piercing region 104 can be seen from a comparison of FIG. 11 and FIG. 12. According to FIG. 11, during the radial piercing analogously to FIGS. 9a to 9c using a conventional cutting insert which does not have any chip-guiding depressions and chip-guiding elevations within the meaning of the present disclosure, relatively long tangled chips are formed. Consequently, no chip breaking to form shorter chips takes place. By contrast, it can be seen from FIG. 12 that, when the cutting insert 204 is used analogously to FIGS. 9a to 9c, the desired short chip formation occurs because of the chip-guiding depressions 80 and chip-guiding elevations 90.

1-15. (canceled)

16. A cutting insert for producing a V-shaped profile in a workpiece by radial piercing relative to an axis of rotation of the workpiece, the cutting insert comprising:
a reference plane;
a V-shaped piercing region having two cutting edges contained in said reference plane and converging in a V-shaped manner towards each other in a viewing direction perpendicular to said reference plane;
a cutting corner connecting said two cutting edges to each other;
a cutting edge angle measured between said two cutting edges in a viewing direction perpendicular to said reference plane and lying in a range of 20° to 60°;
an axis of symmetry contained in said reference plane, said cutting edges being formed mirror-symmetrically to each other relative to said axis of symmetry;
a rake face; and
a plurality of elongate chip-guiding depressions formed in said rake face, said chip-guiding depressions each having a low point lying below said reference plane and each extending parallel to a depression extension axis contained in said reference plane, in a viewing direction perpendicular to said reference plane;
said depression extension axes each extending at a depression chip-guiding angle in a range of from 0° to 45°, said depression chip-guiding angle measured on a side of said cutting corner between said axis of symmetry and said depression extension axis in a viewing direction perpendicular to said reference plane.

17. The cutting insert according to claim 16, wherein said depression chip-guiding angle lies in a range of from 10° to 40°.

18. The cutting insert according to claim 16, wherein at least two of said depression extension axes are disposed mirror-symmetrically to said axis of symmetry in a viewing direction perpendicular to said reference plane.

19. The cutting insert according to claim 16, wherein said chip-guiding depressions, in a viewing direction perpendicular to said reference plane, each have a maximum length measured parallel to said depression extension axis, a maximum width measured perpendicularly to said depression extension axis, and a ratio between said length and said in a range of from 1.1 to 20.

20. The cutting insert according to claim 16, wherein:
said cutting corner is linear in a viewing direction perpendicular to said reference plane and has a maximum cutting corner width, measured in said reference plane perpendicular to said axis of symmetry;
in a viewing direction perpendicular to said reference plane, said chip-guiding depressions keep to a minimum distance, measured parallel to said axis of symmetry, from a point of intersection of said cutting corner with said axis of symmetry; and
said minimum distance is greater by a factor of 1 to 3 than said cutting corner width.

21. The cutting insert according to claim 16, wherein said rake face has a plurality of chip-guiding elevations each extending to above said reference plane, and said plurality of chip-guiding elevations alternately alternate with said chip-guiding depressions in a viewing direction perpendicular to said reference plane.

22. The cutting insert according to claim 21, wherein:
said chip-guiding elevations are elongate and each extend parallel to an elevation extension axis contained in said reference plane in a viewing direction perpendicular to said reference plane;
said elevation extension axes each extend at an elevation chip-guiding angle in a range of from 0° to 45°; and
said elevation chip-guiding angle is measurable on a side of said cutting corner between said elevation extension axis and said axis of symmetry in a viewing direction perpendicular to said reference plane.

23. The cutting insert according to claim 22, wherein:
said chip-guiding elevations and said chip-guiding depressions alternately alternate in a viewing direction perpendicular to said reference plane;
said depression chip-guiding angle of one of said chip-guiding depressions has a difference from one of said elevation chip-guiding angles, said elevation chip-guiding angle belongs to a chip-guiding elevation directly following said chip-guiding depression in a viewing direction perpendicular to said reference plane; and
said difference lies in a range of from 0° to 15°.

24. The cutting insert according to claim 16, wherein said cutting edge angle lies in a range of from 35° to 45°.

25. The cutting insert according to claim 16, wherein at least one of said chip-guiding depressions has an unground, sintered surface.

26. The cutting insert according to claim 16, wherein:
said V-shaped piercing region is a first V-shaped piercing region;
at least one second V-shaped piercing region has two cutting edges contained in said reference plane and converging in a V-shaped manner towards each other in a viewing direction perpendicular to said reference plane; and
said two cutting edges of said at least one second V-shaped piercing region directly follow said two cutting edges of said first V-shaped piercing region perpendicular to said axis of symmetry.

27. A method of using a cutting insert, the method comprising:
using the cutting insert according to claim 16 for radial piercing in a workpiece relative to the axis of rotation of the workpiece; and
rotating the cutting insert or the workpiece about the workpiece axis of rotation.

28. The method according to claim 27, which further comprises maintaining the cutting insert and the workpiece at a standstill relative to each other in an axial direction relative to the workpiece axis of rotation during the radial piercing.

29. A machining method for producing a V-shaped profile in a workpiece, the machining method comprising the following steps:
a) providing a workpiece with a workpiece axis of rotation;
b) providing the cutting insert according to claim 16;
c) rotating the workpiece or the cutting insert about the workpiece axis of rotation;
d) radially moving the workpiece and the cutting insert towards each other relative to the workpiece axis of rotation, causing the cutting corner of the cutting insert to first of all pierce the workpiece; and
e) continuing moving the workpiece and the cutting insert towards each other from step d), causing the two cutting edges to penetrate the workpiece at least in sections.

30. The machining method according to claim 29, which further comprises, in step e), maintaining the cutting insert and the workpiece at a standstill relative to each other in an axial direction relative to the workpiece axis of rotation.
